(19) United States
(12) Patent Application Publication
(10) Pub. No.: US 2012/0054739 A1
(43) Pub. Date: Mar. 1, 2012

(54) METHOD AND APPARATUS FOR DEPLOYMENT OF STORAGE FUNCTIONS ON COMPUTERS HAVING VIRTUAL MACHINES

(75) Inventors: Hiroshi ARAKAWA, Sunnyvale, CA (US); Atsushi MURASE, Kanagawa (JP)

(73) Assignee: HITACHI, LTD., Tokyo (JP)

(21) Appl. No.: 12/869,791

(22) Filed: Aug. 27, 2010

(51) Int. Cl. G06F 15/173; G06F 9/455

(52) U.S. Cl. 718/1; 709/223

(57) ABSTRACT

Embodiments of the invention provide a method for deployment of storage functions on computers having virtual machines. In one embodiment, a storage system comprises a plurality of nodes, each of the nodes including a memory and a processor; and a management computer coupled to the plurality of computers and nodes. According to requirements about a storage function needed for one or more operations to be performed, the management computer determines a location among the plurality of nodes to perform the storage function. The management computer determines the location based on the requirements and characteristics of the storage function.

### BACKGROUND OF THE INVENTION

The present invention relates generally to information systems and, more particularly, to methods and apparatuses for deployment of storage functions on computers having virtual machines.

Recently, the use of virtual servers has been popularized in enterprises. Server virtualization realizes improvement of manageability and server resource utilization as well as quick deployment of servers. With server virtualization, multiple virtual servers (i.e., virtual computing machines) can run on a single physical server. To perform data operation required in enterprises, processes on a physical server or a virtual server can use storage functions to manage and process data. Such storage functions as replication/copying, compression, and encryption are often provided by storage systems (i.e., computer systems dedicated to store and handle data with possessing storage media to store the data). By applying the virtual machine technique mentioned above to both servers and storage computers, storage functions can be run and provided on any nodes including servers and storage computers. U.S. Patent Publication No. 2008/0243947 discloses a storage system capable of possessing a virtual machine including software to control the storage system.

### BRIEF SUMMARY OF THE INVENTION

In the above environment of applying the virtual machine technique to both servers and storage computers, a method to determine the appropriate placement of virtual machines according to requirements for storage function is necessary in order to realize the flexibility/agility to perform the operations and optimization of computing resources usage among the nodes. Moreover, a method to establish virtual connection for data transfer between a virtual machine of storage function and a virtual machine of software that makes use of the storage function in one physical computer is also required to achieve coexistence of the aforesaid virtual machines in the single physical server or storage computer.

Exemplary embodiments of the invention provide a method for deployment of storage functions on computers having virtual machines (VMs). According to specific embodiments of the present invention, both servers and storage computers possess virtual machine software that enables them to run virtual machines including storage function and/or software such as application software and DBMS (Database Management System). A management computer linked to the nodes (servers and storage computers) determines the placement of virtual machines, especially of storage function according to requirements from an operation that uses the storage function. For the determination process, the management computer maintains and refers to the node/VM configuration information, operation information including the requirements, target data information aggregated to the management computer, and storage function information including estimated function performance. Moreover, the management computer also generates setting information for the virtual machine software on the nodes to establish virtual connection between a virtual machine of storage function and a virtual machine of software that makes use of the storage function in a single node as necessary. The management computer instructs to establish the connection with the settings.

In accordance with an aspect of the present invention, a storage system comprises a plurality of nodes, each of the nodes including a memory and a processor; and a management computer coupled to the plurality of computers and nodes. According to requirements about a storage function needed for one or more operations to be performed, the management computer determines a location among the plurality of nodes to perform the storage function. The management computer determines the location based on the requirements and characteristics of the storage function.

In some embodiments, the plurality of nodes include one or more servers and one or more storage computers, and the management computer determines whether the location is a server or a storage computer based on the one or more operations. The management computer determines the location to perform the storage function based on location and size of data subject to the storage function. The virtual machine connection relationship for the storage function is set by a data access path to access data required in order to perform the storage function. A type of the connection relationship is selected from among in-band, out of band with dual write, and out of band with reading data. The management computer checks whether a virtual machine that will use the storage function is located at the same node that will possess a virtual machine of the storage function; and if there is the coexistence of the virtual machines at the same in one node, the management computer identifies a target and an initiator to be used for performance of the storage function. The requirements include time limit and quantity of data subject to the storage function, and the management computer determines the number of virtual machines of the storage function based on the time limit and the quantity of data. The plurality of nodes include a plurality of virtual machines, and determination of the location by the management computer comprises identifying number and locations of the virtual machines to deploy the storage function. The determination of the location by the management computer comprises identifying number and locations of the virtual machines that provide the storage function and of the virtual machines that use the storage function.

Another aspect of the invention is directed to a management computer in a storage system that includes a plurality of computers and a plurality of nodes each having a node memory and a node processor, the management computer being coupled to the plurality of computers and nodes. The management computer comprises a memory, a processor, and a storage function deployment module to deploy a storage function in response to a storage function deployment request from one of the plurality of computers. According to requirements about a storage function needed for one or more operations to be performed, the storage function deployment module determines a location among the plurality of nodes to perform the storage function. The storage function deployment module determines the location based on the requirements and characteristics of the storage function.

In specific embodiments, the storage function deployment module determines the location to perform the storage function based on location and size of data subject to the storage function. The storage function deployment module checks whether a virtual machine that will use the storage function is located at the same node that will possess a virtual machine of the storage function; and if there is the coexistence of the virtual machines at the same in one node, the storage function deployment module identifies a target and an initiator to be used for performance of the storage function.

Another aspect of this invention is directed to a method of storage function deployment in a storage system that includes a plurality of computers and a plurality of nodes each having a memory and a processor. The method comprises determining a location among the plurality of nodes to perform the storage function according to requirements about a storage function needed for one or more operations to be performed; and determining the location from the plurality of locations based on the requirements and characteristics of the storage function.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of an information system configuration in which the method and apparatus of the invention may be applied.

FIG. 2 illustrates an exemplary configuration of a server in the information system of FIG. 1.

FIG. 3 illustrates an example of a memory in the server of FIG. 2.

FIG. 4 illustrates an exemplary configuration of a storage system that is connected to and shared by the servers in the information system of FIG. 1.

FIG. 5 illustrates an example of a memory in the storage system of FIG. 4.

FIG. 6 illustrates an exemplary configuration of a management computer in the information system of FIG. 1.

FIG. 7 shows an example of the node information.

FIG. 8 shows an example of the virtual machine catalog.

FIG. 9 shows an example of the virtual machine placement information.

FIG. 10 shows an example of the operation information.

FIG. 11 shows an example of the target data information.

FIG. 12 shows an example of the storage function information.

FIG. 13 is a flow diagram illustrating an example of a storage function deployment process.

FIG. 14 is a flow diagram illustrating an example of a process to determine an appropriate placement of storage function.

FIG. 15 is a flow diagram illustrating an example of a process to generate necessary settings to deploy the storage function.

FIG. 16 illustrates examples of storage functions, connection configurations between the virtual machine providing the storage function and the virtual machine that will use the storage function, and types of virtual SCSI port.

FIG. 17 shows examples of internal logical/virtual connections and related components.

FIG. 18 is a flow diagram illustrating an example of a process to execute the deployment of virtual machine.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for deployment of storage functions on computers having virtual machines.

A. System Configuration

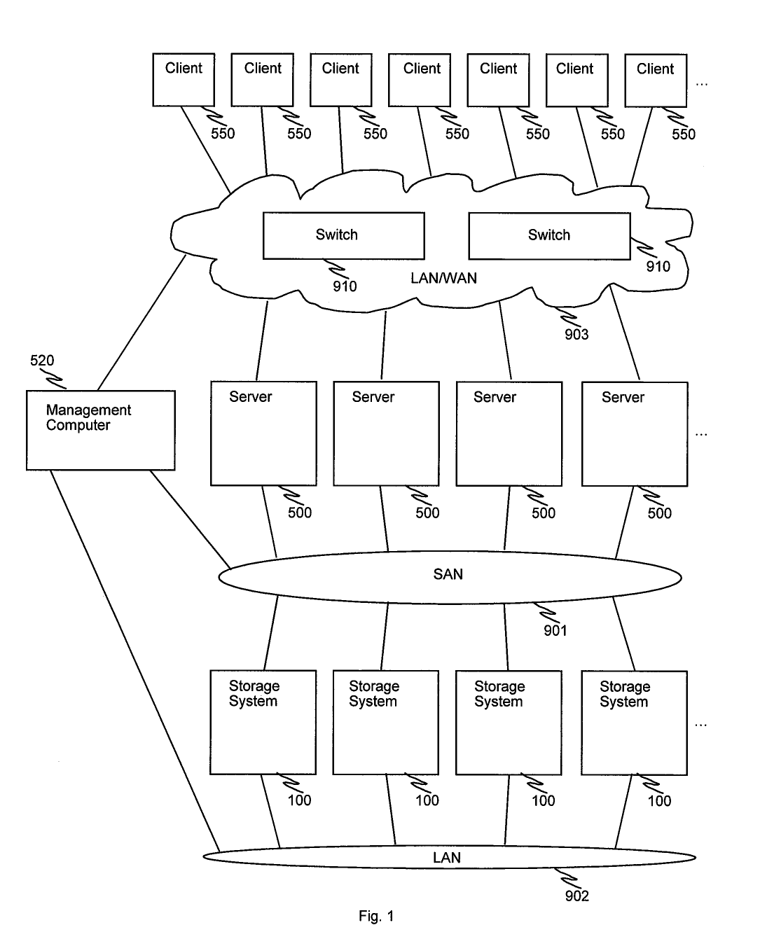

FIG. 1 illustrates an example of an information system configuration in which the method and apparatus of the invention may be applied. The information system of FIG. 1 includes one or more storage systems 100 in communication with one or more servers 500 and a management computer 520. As shown in FIG. 1, one or more clients 550 are connected to the servers 500 via a LAN/WAN 903 constructed by one or more switches 910. A client 550 sends a request to be processed to the server 500, and then the server 500 responds with the result of the process for the request to the client 550. The servers 500 and the management computer 520 are connected to the storage systems 100 via a SAN 901 (e.g., Fibre Channel, Fibre Channel over Ethernet, iSCSI(IP)). The servers 500, the management computer 520, and the storage systems 100 are connected to each other via the LAN 902 and LAN 903 (e.g., IP network).

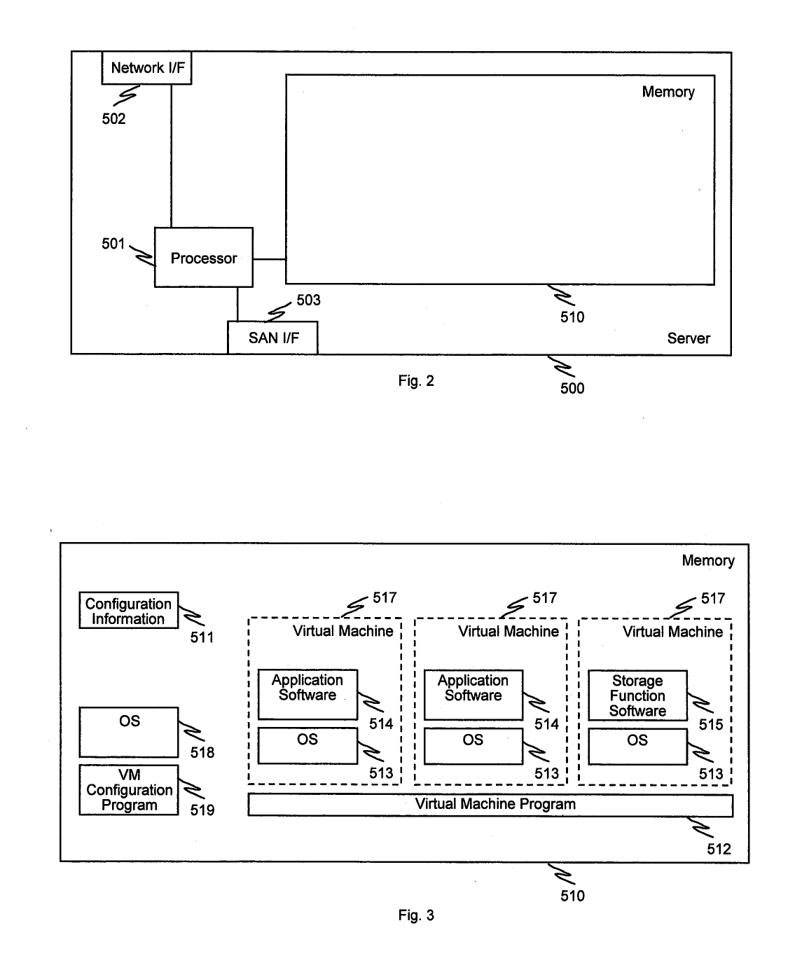

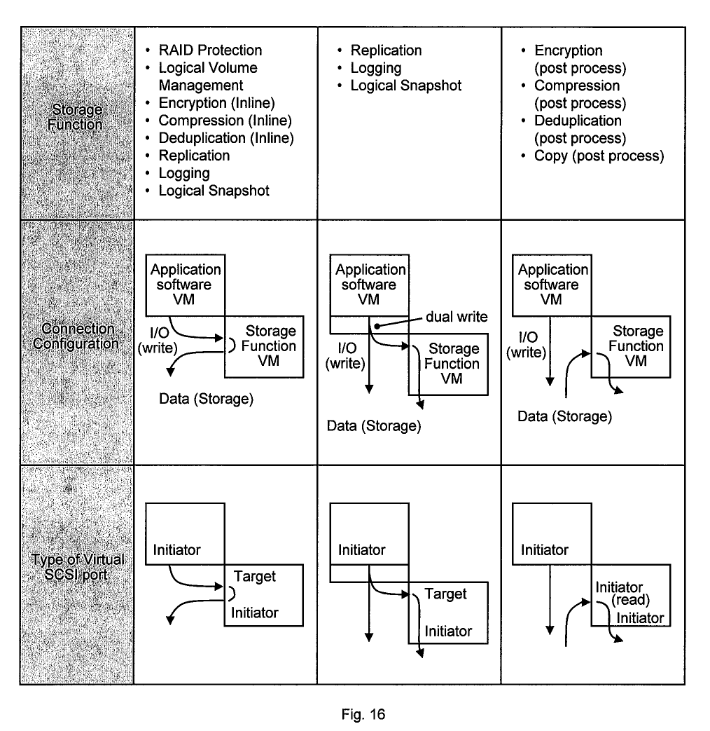

As illustrated in FIG. 2, a server 500 includes a processor 501, a network interface 502 connected to the LAN 903, a SAN interface 503 connected to the SAN 901, and a memory 510. The server 500 includes a virtual machine program 512 to enable the OS (Operating System) 513 and other software to be executed in a virtual machine 517 provided by the virtual machine program 512 as illustrated in the memory 510 of FIG. 3. For example, in FIG. 3, one or more application softwares 514 may be executed on the OS 513 in some virtual machines 517, and in other virtual machines 517 at least one storage function software 515 may be executed. The storage function software 515 provides at least one storage function such as replication, copy, encryption, and compression to handle data. Examples of storage functions are shown in FIG. 16. Files/data for the OS 513, application software 514, and storage function software 515 may be stored in one or more volumes provided by the storage system 100 or a DAS (direct attached storage) of the server 500 itself. Basically the OS 513 issues read and write commands to the storage systems 100 to access data stored in the storage systems 100 according to I/O requests from the application software 514 or storage function software 515. The memory 510 of the server 500 may also maintain the configuration information 511 regarding virtual machine configuration mentioned above, the OS 518, and the virtual machine configuration program 519 that communicates with the management computer 520 to establish the virtual machines 517 described above.

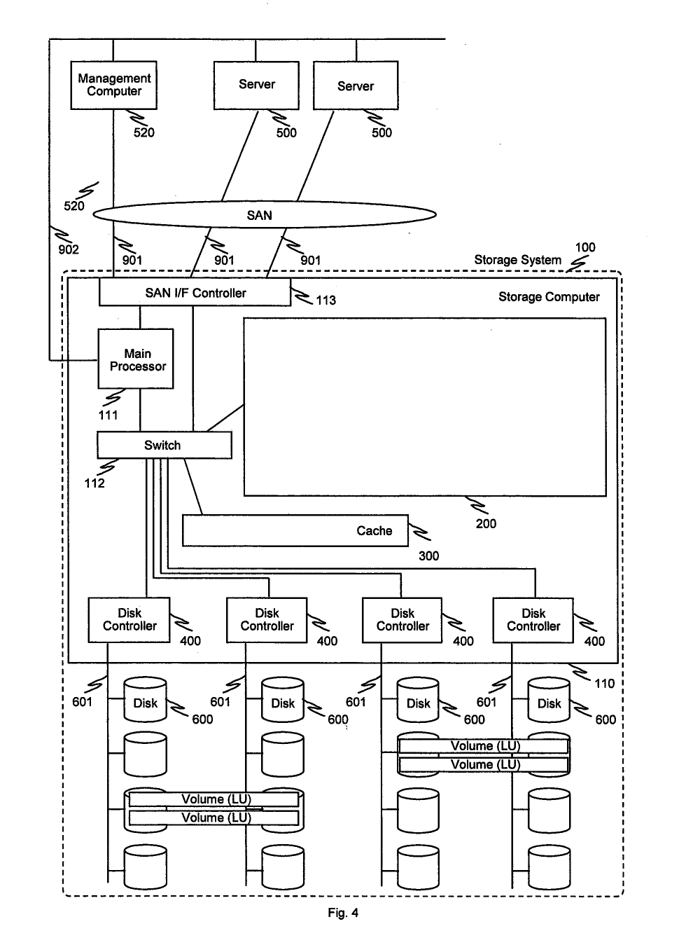

FIG. 4 illustrates an exemplary configuration of the aforesaid storage system 100 that is connected to and shared by the servers 500 via the SAN 901. The storage system 100 of FIG. 4 includes a storage computer 110, a main processor 111, a switch 112, a SAN interface 113, a memory 200, a cache 300, disk controllers 400, disks 600 (e.g., HDD), and backend paths 601 (e.g., Fibre Channel, SATA, SAS, iSCSI(IP), etc.).

The storage computer 110 manages and provides volumes (logical units) of the storage system 100 as storage area to store data used by the servers 500. That is, the storage computer 110 processes read and write commands from the servers 500 to provide access means to the volumes. The volumes may be protected by storing parity code (i.e., by RAID configuration) or mirroring.

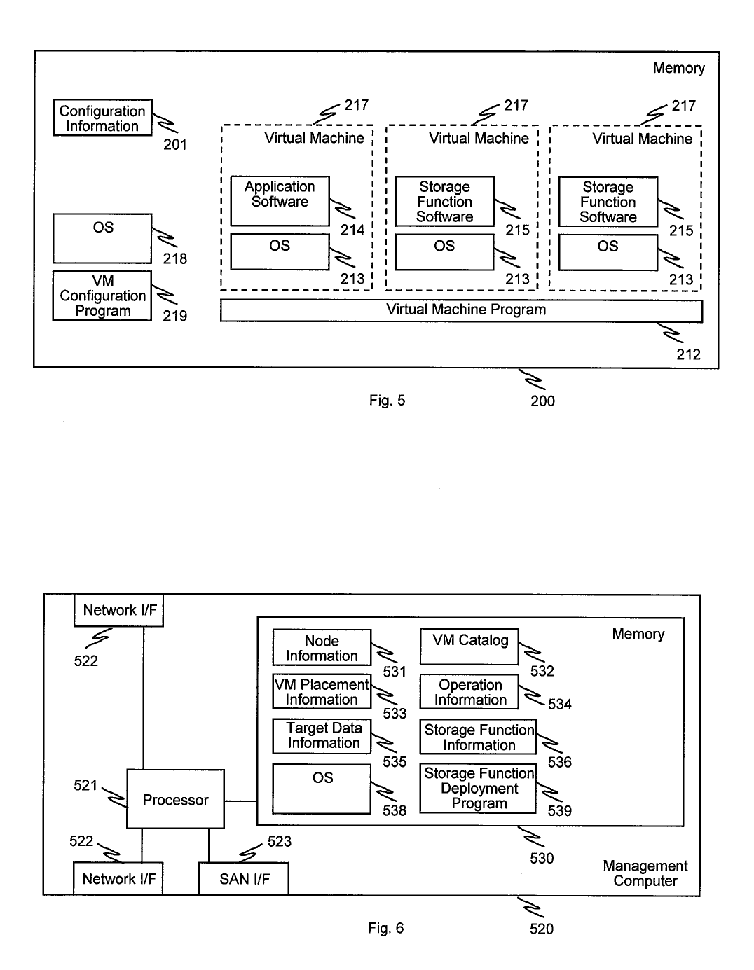

As illustrated in the memory 200 of FIG. 5, the storage computer 110 may include a virtual machine program 212 to enable OS 213 and other software to be executed in a virtual machine 217 provided by the virtual machine program 212. For example, one or more application softwares 214 may be executed on the OS 213 in some virtual machines 217, and in other virtual machines 217 at least one storage function software 215 may be executed. Files/data for the OS 213, application software 214, and storage function software 215 may be stored in one or more volumes provided by the storage system 100 itself. Basically the OS 213 issues read and write commands according to I/O requests from the application software 214 or storage function software 215 and the storage computer 110 can also process the read and write commands. The memory 200 of the storage computer 110 may also maintain configuration information 201 regarding the virtual machine configuration mentioned above, the OS 218, and the virtual machine configuration program 219 that communicates with the management computer 520 to establish virtual machines 217 described above. The aforesaid read and write processes may also be realized as storage functions.

FIG. 6 illustrates an exemplary configuration of the management computer 520. As illustrated in FIG. 6, the management computer 520 includes a processor 521, network interfaces 522 connecting to the LAN 902 and LAN 903, a SAN interface 523 connecting to the SAN 901, and a memory 530. By a storage function deployment program 539 stored in the memory 530, the management computer 520 executes the management of the virtual machines 517 of the servers 500 and the virtual machines 217 of the storage computers 110. The details of the process are described later. In order to achieve the management the virtual machines, the management computer 520 uses the following information stored in the memory 530: node information 531, virtual machine catalog 532, virtual machine placement information 533, operation information 534, target data information 535, and storage function information 536. These types of information may be defined and updated by the user or by automatic aggregation wherein the management computer 520 collects related information maintained by the servers 500 and storage computers 110.

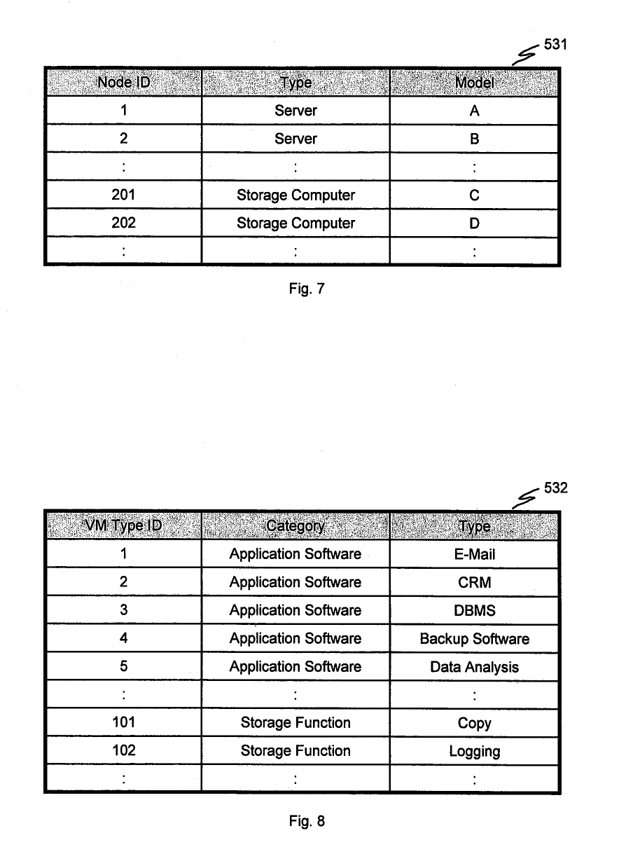

FIG. 7 shows an example of the node information 531. This information maintains the “type” of each node (server 500 or storage computer 110) existing in the information system. In the example, the “model” indicates a specification of each server 500 or storage computer and it can be recognized performance factors such as processor speed, bus clock frequency, memory size and so on. This information may include other information regarding node configuration such as network connection among the nodes.

FIG. 8 shows an example of the virtual machine catalog 532. This information maintains the sorts of virtual machines that can be applied, including “category” (e.g., application software or storage function) and “type” (e.g., E-Mail, Backup Software, Data Analysis, Copy, Logging, etc.) for each “VM Type ID.”

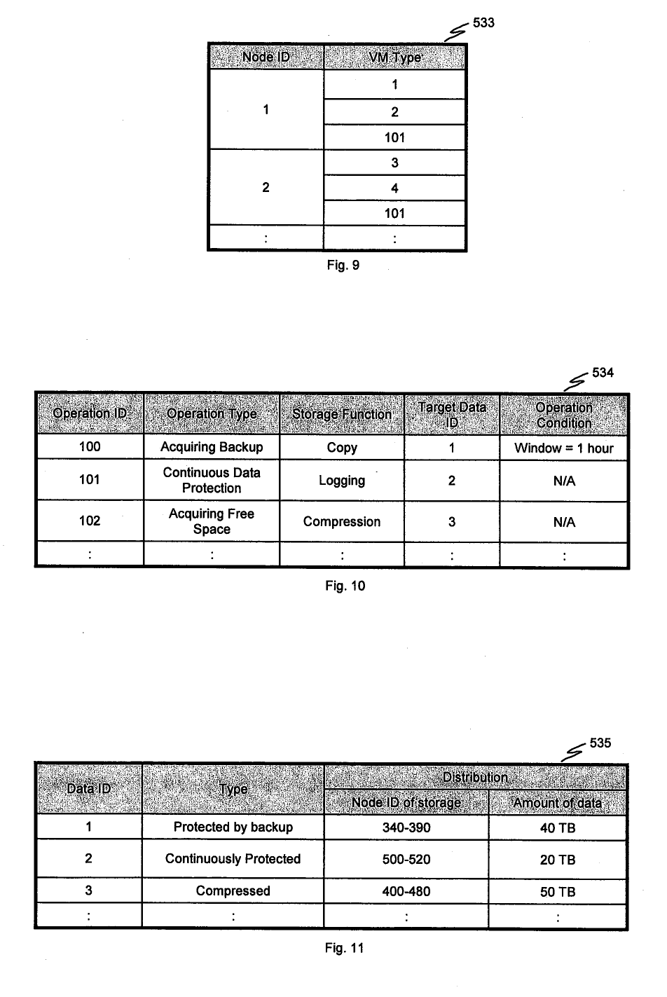

FIG. 9 shows an example of the virtual machine placement information 533 that maintains the relation between nodes and located virtual machines. In this example, each node identified by “Node ID” has a plurality of “VM Type” entries. Under “VM Type,” each entry is a virtual machine type ID which is ID defined in virtual machine catalog 532.

FIG. 10 shows an example of the operation information 534. This information indicates specification and requirements of each data operation aimed by users of the information system. As illustrated in FIG. 10, the operation information 534 maintains type of required storage function for the operation under “Operation Type” and “Storage Function” for each “Operation ID.” This information also specifies data to be processed in each operation under “Target Data ID.” The operation information 534 can also include conditions/requirements such as time limit (e.g., backup window) for each operation under “Operation Condition.” Another example of conditions/requirements is the quantity of data subject to the storage function. In specific embodiments, the type of storage function is set by the data access path required to access data in order to perform the storage function.

FIG. 11 shows an example of the target data information 535. For each “Data ID,” there is “Type” and “Distribution.” In addition to attribute of data under “Type,” this information maintains the amount/size and location (i.e., distribution) of data to be processed in each operation under “Distribution.” In other words, this information includes “meta data” of the data. Data ID corresponds to the data ID used in the operation information 534. By using the operation information 534 and the target data information 535, the management computer 520 can recognize the data to be processed in each operation.

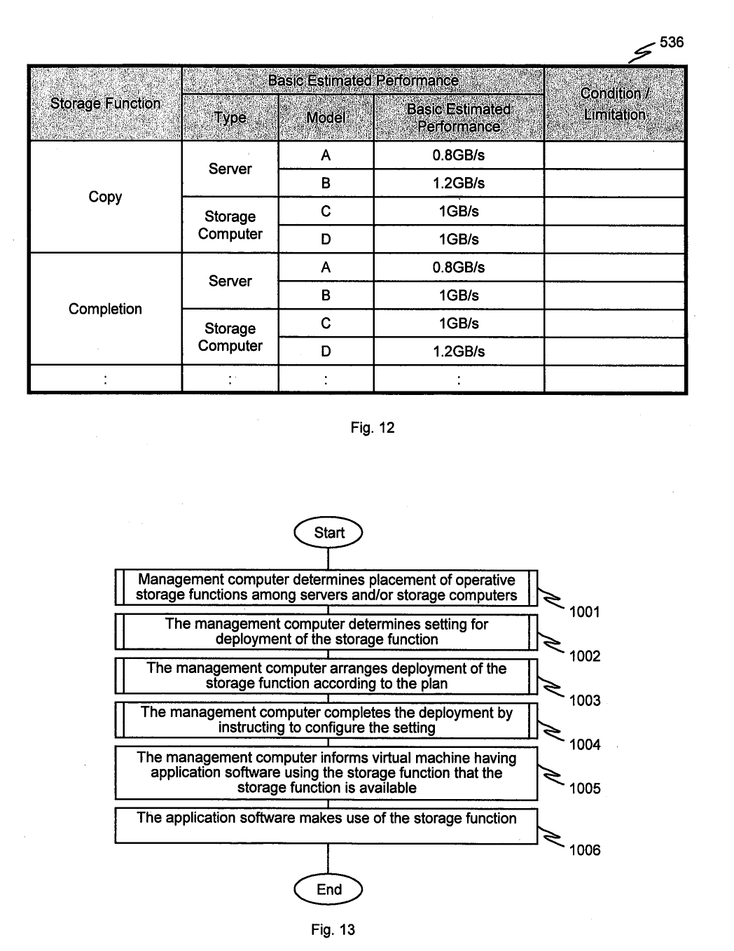

FIG. 12 shows an example of the storage function information 536. The storage function information 536 maintains the type of available storage functions under “Type” and estimated performance of each storage function in each node. This information may also include other specification such as conditions/limitations to be considered to use the storage function.

B. Overview of Storage Function Deployment Process

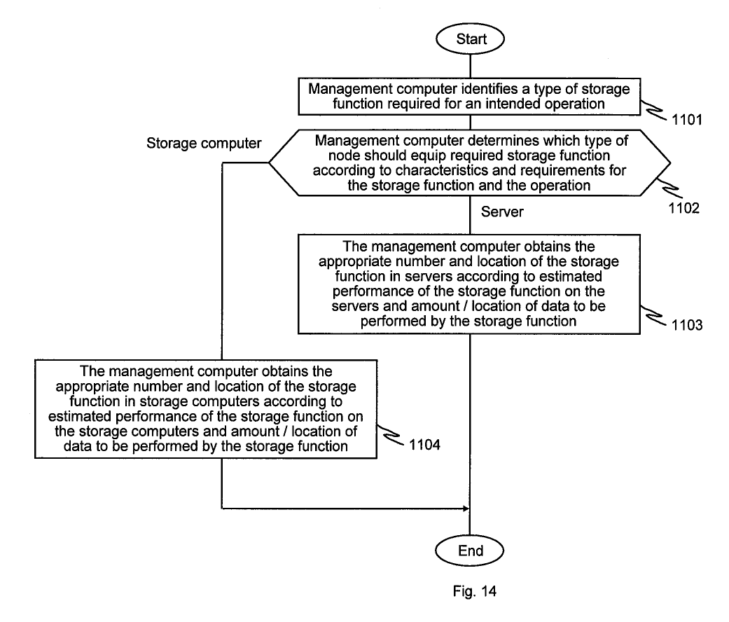

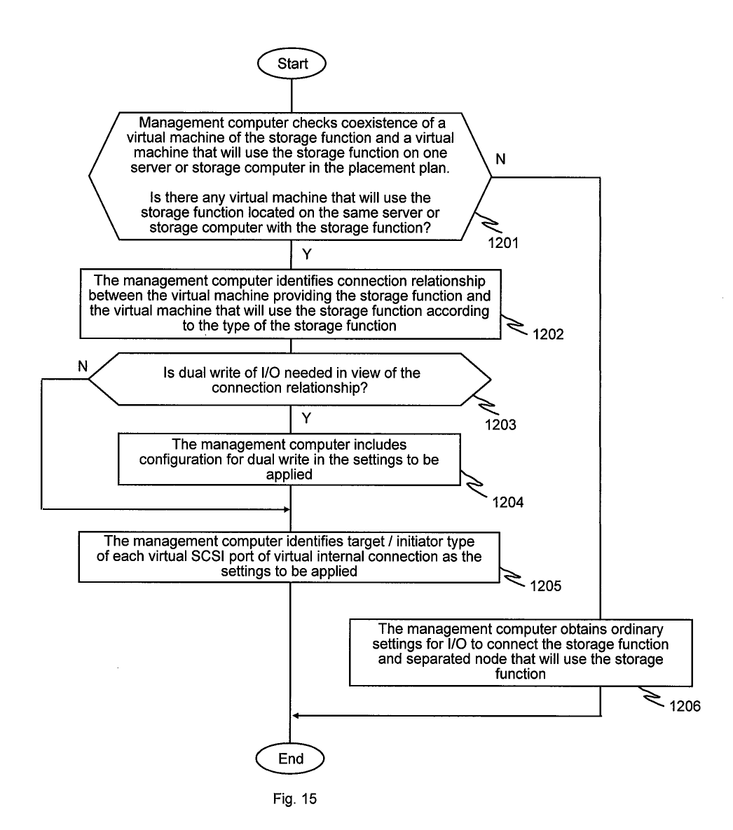

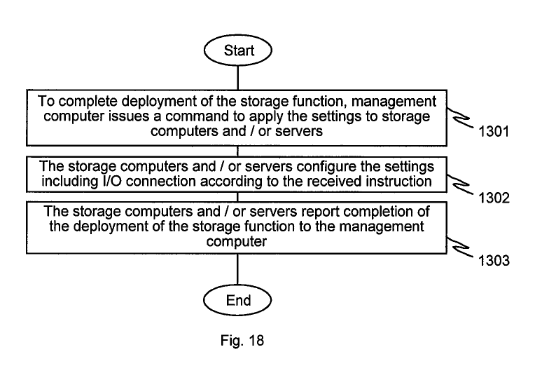

FIG. 13 is a flow diagram illustrating an example of a storage function deployment process. At step 1001, the management computer 520 makes a plan for the placement of storage functions among the servers 500 and storage computers 110. The detailed process of determination of the placement is described below (see FIG. 14). At step 1002, the management computer 520 specifies the settings for deployment of the storage functions. The detailed process of determination of the setting is described below (see FIG. 15). At step 1003, the management computer 520 operates the projected deployment of the storage functions. This process may be achieved with a known method such as the method disclosed in U.S. Patent Publication No. 2008/0243947. At step 1004, the management computer 520 completes the deployment of the storage function by applying the above settings to the related nodes. The detailed processing of configuring the settings is described below (see FIG. 18). At step 1005, the management computer 520 notifies that the storage function is available to the related application software 514/214 which will use the storage function. The management computer 520 may also send other configuration information (e.g., location, address or identifier) to use the storage function to the application software 514/214 or the related virtual machine 517/217. At step 1006, according to the notification, the application software 514/214 starts to use the storage function.

C. Placement Determination Process

FIG. 14 is a flow diagram illustrating an example of a process to determine an appropriate placement of storage function. This process corresponds to step 1001 in FIG. 13. At step 1101, the management computer 520 recognizes a type of storage function needed for an operation to be performed. At step 1102, the management computer 520 determines which type of node (server 500 or storage computer 110) should equip the required storage function. The management computer 520 may make the decision according to characteristics and requirements for the storage function and the operation. For example, if the operation is for the data dispersed (virtualized) in multiple storage systems 100, it may be preferable that the storage function be deployed in the server 500 because the server 500 can handle the multiple storage systems 100 via the SAN 901. As another example, if the data to be processed with the operation is located in one storage system 100, the storage computer 110 of the storage system 100 may be preferable as the location of the storage function to reduce data transfer (i.e., bandwidth usage) in the SAN 901 and overhead regarding data transfer. Other factors such as load status/memory usage of each server 500 or storage computer 110 and supposed amount/pace of data transfer can be considered to make the decision. If the management computer 520 determines that the storage function should be deployed in the server 500, the process proceeds to step 1103. If the management computer 520 determines that the storage function should be deployed in the storage computer 110, the process proceeds to step 1104.

At step 1103, the management computer 520 determines the number and location of the storage function to be deployed among the servers 500. The management computer 520 can acquire the appropriate numbers of virtual machines 517 of the storage function required for the operation by reference to the node information 531, operation information 534, target data information 535, and storage function information 536. As one exemplary method, the required number of the virtual machine 517 can be obtained as follows.

(The number of the virtual machine 517)=rounding up of ((The amount of the data to be processed)/((performance of the storage function)×(time limit of the operation)))

The preferable location (i.e., placement) of the virtual machine 517 can be determined by the distribution of the data to be processed in the operation. In other words, the management computer 520 chooses one or more appropriate servers 500 to have the storage function. Other factors such as load status/memory usage of each server 500 and load status of the SAN 901 can be considered.

At step 1104, the management computer 520 determines the number and location of the storage function to be deployed among the storage computers 110. The management computer 520 can acquire the appropriate numbers of virtual machines 217 of the storage function required for the operation by reference to the node information 531, operation information 534, target data information 535, and storage function information 536. As one exemplary method, the required number of the virtual machines 217 can be obtained as follows.

(The number of the virtual machine 217)=rounding up of ((The amount of the data to be processed)/((performance of the storage function)×(time limit of the operation)))

The preferable location (i.e., placement) of the virtual machine 217 can be determined by the distribution of the data to be processed in the operation. In other words, the management computer 520 chooses one or more appropriate storage computers 110 to have the storage function. Other factors such as projected load status/memory usage of the storage computer 110 and scheduling of the operation can be considered.

D. Setting Generation Process

FIG. 15 is a flow diagram illustrating an example of a process to generate necessary settings to deploy the storage function. This process corresponds to step 1002 in FIG. 13. At step 1201, the management computer 520 checks whether a virtual machine 517/217 that will use the storage function is located on the same server 500 or the same storage computer 110 that will possess a virtual machine 517/217 of the storage function. If there is the coexistence in one server 500 or one storage computer 110, the process proceeds to step 1202. Otherwise, the process proceeds to step 1206.

At step 1202, the management computer 520 identifies the connection relationship between the virtual machine 517/217 providing the storage function and the virtual machine 517/217 that will use the storage function. The management computer 520 can recognize a form of the relationship to be applied as shown in FIG. 16. That is, the management computer 520 can identify the relationship and required settings from the type and usage of the storage function because the settings have a direct relation to the type and usage of the storage function as categorized in FIG. 16. Examples of the type of the connection relationship include in-band, out of band with dual write, and out of band with reading data.

At step 1203, the management computer 520 checks the necessity of dual write (splitting of write I/O shown in FIG. 16) for the storage function. If dual write will be applied, the process proceeds to step 1204. Otherwise, the process proceeds to step 1205. At step 1204, the management computer 520 includes configuration for dual write in the settings to be applied. At step 1205, the management computer 520 identifies the target/initiator type of each virtual SCSI port of virtual internal connection as the setting to be applied. SCSI commands related to the storage function are given from the initiator port to the target port.

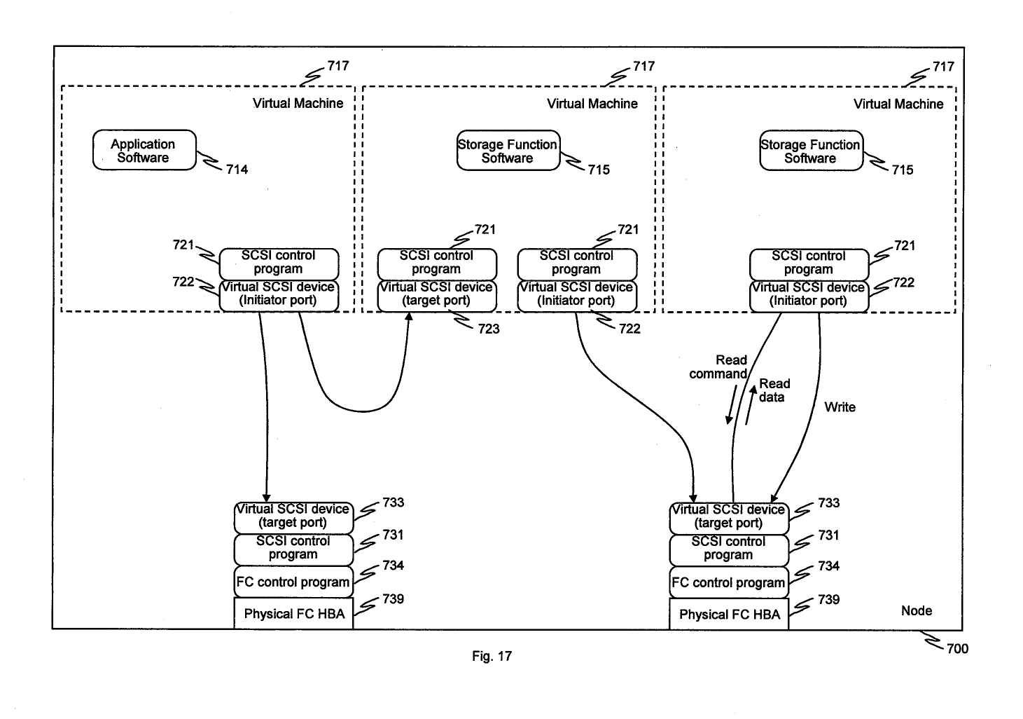

FIG. 17 shows examples of internal logical/virtual connections and related components. In FIG. 17, a node 700 (i.e., a server 500 or a storage computer 110) has FC host bus adapters (HBA) 739 as hardware components controlled by the FC control program 734. Within the node 700, the storage I/O is realized based on SCSI that is a well-known logical protocol/specification for storage I/O. Applying SCSI in the node is realized with the virtual SCSI devices 722 as virtual objects and the SCSI control program 721. Therefore, internal storage I/O between virtual machines 717 is also realized as SCSI connection logically as shown in the diagram. The target/initiator type resides in an attribution of virtual SCSI. In order to achieve the internal connections, other related information such as addresses regarding the devices may be included in the settings.

At step 1206, the management computer 520 obtains the ordinary settings for I/O to connect the storage function and separated node that will use the storage function. This may be achieved with a known method such as the method disclosed in U.S. Patent Publication No. 2008/0243947.

E. Deployment Execution Process

FIG. 18 is a flow diagram illustrating an example of a process to execute the deployment of virtual machine 517/217. This process corresponds to step 1004 in FIG. 13. At step 1301, the management computer issues an instruction to apply the settings to one or more related storage computers 110 and/or servers 500. At step 1302, the storage computers 110 and/or the servers 500 configure the settings including I/O connection according to the received instruction. At step 1303, the storage computers 110 and/or the servers 500 report completion of the deployment of the storage function to the management computer 520.

With the method described above, an appropriate placement of virtual machines, especially of storage function according to requirements from the operation, is determined, and the virtual machines are deployed based on the placement plan even for the case where both a virtual machine of storage function and a virtual machine of software that makes use of the storage function are located in one node. This achieves flexibility/agility to perform the operations and efficient use of computing resources among the nodes.

The above method may also be applied to the deployment of softwares/modules such as application software included in virtual machines as well as storage functions because the definition/categorization of software or modules could not be strict in many cases; moreover, they also have correlations such as the relations mentioned above. The above management task performed by the management computer 520 for deployment of storage functions can be achieved using a computer (such as a server 500 and a storage controller 110) other than the management computer 520.

Of course, the system configurations illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for deployment of storage functions on computers having virtual machines. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising:
a plurality of nodes, each of the nodes including a memory and a processor; and
a management computer coupled to the plurality of computers and nodes;
wherein according to requirements about a storage function needed for one or more operations to be performed, the management computer determines a location among the plurality of nodes to perform the storage function; and
wherein the management computer determines the location based on the requirements and characteristics of the storage function.

2. The storage system according to claim 1,
wherein the plurality of nodes include one or more servers and one or more storage computers; and
wherein the management computer determines whether the location is a server or a storage computer based on the one or more operations.

3. The storage system according to claim 1,
wherein the management computer determines the location to perform the storage function based on location and size of data subject to the storage function.

4. The storage system according to claim 1,
wherein virtual machine connection relationship for the storage function is set by a data access path to access data required in order to perform the storage function.

5. The storage system according to claim 4,
wherein a type of the connection relationship is selected from among in-band, out of band with dual write, and out of band with reading data.

6. The storage system according to claim 1,
wherein the management computer checks whether a virtual machine that will use the storage function is located at the same node that will possess a virtual machine of the storage function; and
wherein if there is coexistence of the virtual machines at the same node, the management computer identifies a target and an initiator to be used for performance of the storage function.

7. The storage system according to claim 1,
wherein the requirements include time limit and quantity of data subject to the storage function; and
wherein the management computer determines the number of virtual machines of the storage function based on the time limit and the quantity of data.

8. The storage system according to claim 1,
wherein the plurality of nodes include a plurality of virtual machines; and
wherein determination of the location by the management computer comprises identifying number and locations of the virtual machines to deploy the storage function.

9. The storage system according to claim 8,
wherein the determination of the location by the management computer comprises identifying number and locations of the virtual machines that provide the storage function and of the virtual machines that use the storage function.

10. A management computer in a storage system that includes a plurality of computers and a plurality of nodes each having a node memory and a node processor, the management computer being coupled to the plurality of computers and nodes, the management computer comprising:
a memory;
a processor; and
a storage function deployment module to deploy a storage function in response to a storage function deployment request from one of the plurality of computers;
wherein according to requirements about a storage function needed for one or more operations to be performed, the storage function deployment module determines a location among the plurality of nodes to perform the storage function; and
wherein the storage function deployment module determines the location based on the requirements and characteristics of the storage function.

11. The management computer according to claim 10,
wherein the storage function deployment module determines the location to perform the storage function based on location and size of data subject to the storage function.

12. The management computer according to claim 10,
wherein virtual machine connection relationship for the storage function is set by a data access path to access data required in order to perform the storage function.

13. The management computer according to claim 12,
wherein a type of the connection relationship is selected from among in-band, out of band with dual write, and out of band with reading data.

14. The management computer according to claim 10,
wherein the storage function deployment module checks whether a virtual machine that will use the storage function is located at the same node that will possess a virtual machine of the storage function; and
wherein if there is coexistence of the virtual machines at the same node, the storage function deployment module identifies a target and an initiator to be used for performance of the storage function.

15. The management computer according to claim 10,
wherein the requirements include time limit and quantity of data subject to the storage function; and
wherein determination of the location by the storage function deployment module comprises identifying number and locations of the virtual machines to deploy the storage function based on the time limit and the quantity of data.

16. A method of storage function deployment in a storage system that includes a plurality of computers and a plurality of nodes each having a memory and a processor, the method comprising:
determining a location among the plurality of nodes to perform the storage function according to requirements about a storage function needed for one or more operations to be performed; and
determining the location from the plurality of locations based on the requirements and characteristics of the storage function.

17. The method according to claim 16,
wherein the location to perform the storage function is determined based on location and size of data subject to the storage function.

18. The method according to claim 16,
wherein virtual machine connection relationship for the storage function is set by a data access path to access data required in order to perform the storage function.

19. The method according to claim 16, further comprising:
checking whether a virtual machine that will use the storage function is located at the same node that will possess a virtual machine of the storage function; and
identifying a target and an initiator to be used for performance of the storage function if there is coexistence of the virtual machines at the same node.

20. The method according to claim 16, wherein the requirements include time limit and quantity of data subject to the storage function, the method further comprising:
determining the number of virtual machines of the storage function based on the time limit and the quantity of data.
